(19) United States
(12) Patent Application Publication
(10) Pub. No.: US 2026/0001490 A1
(43) Pub. Date: Jan. 1, 2026

(54) VEHICLE HAVING LOAD FLOOR PROP ROD

(71) Applicant: Ford Global Technologies, LLC, Dearborn, MI (US)

(72) Inventors: Irvin Jair Hernandez Hernandez, Tecamac (MX); Marco Antonio Bello Xelhuantzi, Toluca (MX); Sergio Eduardo Vazquez Mondragon, Benito Juarez (MX)

(73) Assignee: Ford Global Technologies, LLC, Dearborn, MI (US)

(21) Appl. No.: 18/756,388

(22) Filed: Jun. 27, 2024

(51) Int. Cl. B60R 5/04

(52) U.S. Cl. CPC B60R 5/044

(57) ABSTRACT

A vehicle cargo storage system configured to be located in a floor of a vehicle. The vehicle cargo storage system has a compartment configured to extend into and below the floor of the vehicle, a load floor cover movable between a closed position covering the compartment and an upright open position to expose the compartment, and a prop rod coupled to an underside of the load floor cover. The prop rod is configured to be stowed on the bottom side of the load floor cover and is deployed to a deployed position extending downward from the load floor cover to support the load floor cover in the open position.

### FIELD OF THE DISCLOSURE

The present disclosure generally relates to vehicle storage systems, and more particularly relates to a load floor holder for a vehicle cargo storage system.

### BACKGROUND OF THE DISCLOSURE

Motor vehicles are commonly equipped with storage compartments for storing cargo. For example, the rear cargo area of a vehicle may include a hidden storage compartment that extends in a recessed area below the cargo floor and has a removable load floor cover. Quite often, a spare tire or other items may be stored within the rear cargo area storage compartment. It would be desirable to provide for a cargo storage system that allows efficient access to the storage compartment.

### SUMMARY OF THE DISCLOSURE

According to a first aspect of the present disclosure, a vehicle cargo storage system is configured to be located in a floor of a vehicle. The vehicle cargo storage system has a compartment configured to extend into and below the floor of the vehicle, a cover movable between a closed position covering the compartment and an upright open position to expose the compartment, and a prop rod coupled to an underside of the cover. The prop rod is configured to be stowed on the bottom side of the cover and is deployed to a deployed position extending downward from the cover to support the cover in the open position.

Embodiments of the first aspect of the present disclosure can include any one or a combination of the following features:
the prop rod comprises a hinge connecting one end of the prop rod to the bottom side of the cover;
the hinge comprises a pin rotatably coupled to a connector;
the cover has a slot on the bottom side, wherein the prop rod is stowed in the slot in the stowed position;
the slot is configured to frictionally engage the prop rod;
the cover is a load floor cover that provides a load floor in the closed position;
the compartment is located in a rear portion of the vehicle;
the prop rod has a terminal end configured to be supported on the floor in the deployed position;
the prop rod is configured to engage a sill plate on the cargo floor;
the sill plate has a member configured to engage the terminal end of the prop rod; and
the cover has a cover hinge.

According to a second aspect of the present disclosure, a vehicle cargo storage system is configured to be located in a cargo floor of a vehicle. The vehicle cargo storage system has a compartment configured to extend into and below the cargo floor of the vehicle, a load floor cover movable between a closed position covering the compartment and providing a load floor and an upright open position to expose the compartment, and a prop rod pivotably coupled to a bottom side of the load floor cover. The prop rod is configured to be stowed on the bottom side of the load floor cover and is deployed to a deployed position extending downward from the load floor cover to support the load floor cover in the open position, wherein a hinge connects one end of the prop rod to the bottom surface of the load floor cover.

Embodiments of the second aspect of the present disclosure can include any one or a combination of the following features:
the hinge comprises a pin rotatably coupled to a connector;
the load floor cover has a slot on the bottom side, wherein the prop rod is stowed in the slot in the stowed position;
the slot is configured to frictionally engage the prop rod;
the compartment is located in a rear portion of the vehicle;
the prop rod has a terminal end configured to engage the floor in the deployed position;
the prop rod is configured to engage a sill plate in the deployed position;
the sill plate has a member configured to engage the terminal end of the prop rod; and
the cover has a cover hinge.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear perspective view of a motor vehicle having a cargo storage system shown including a load floor cover in a closed position covering a storage compartment in a rear cargo area, according to one embodiment;

FIG. 2 is a rear perspective view of the motor vehicle showing the cargo storage system with the load floor cover in an open position and supported by a prop rod;

FIG. 3 is an enlarged perspective view of the cargo storage system with the load floor cover in the closed position;

FIG. 4 is an enlarged perspective view of the cargo storage system with the load floor cover in the open position showing the prop rod stowed in the load floor cover;

FIG. 5 is an enlarged perspective view of the cargo storage system with the load floor cover in the open position and a prop rod partially deployed;

FIG. 6 is an enlarged perspective view of the cargo storage system with the load floor cover in the open position and the prop rod fully deployed; and

FIG. 7 is an exploded view of the prop rod stowed in and removed from the load floor cover.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

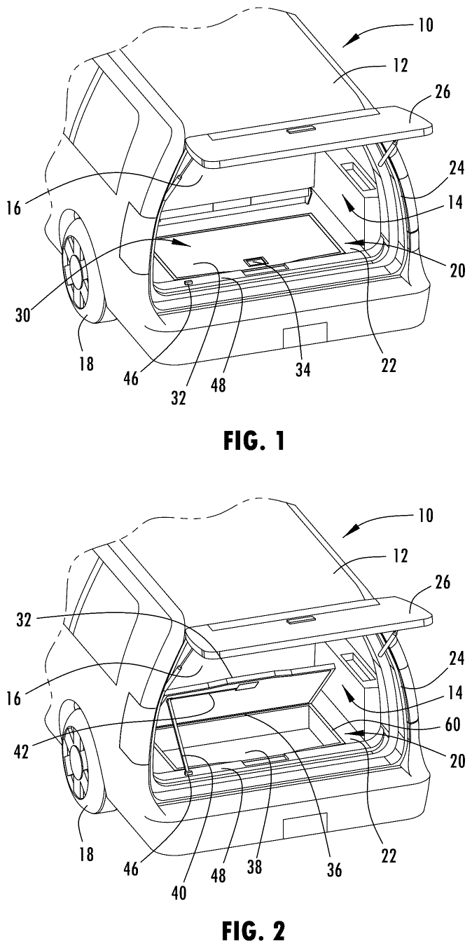

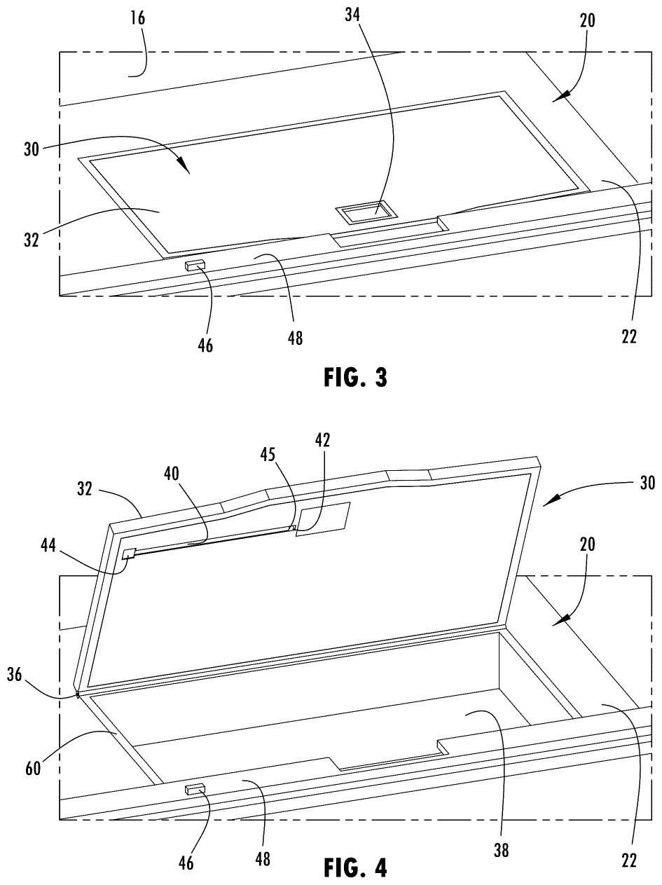

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle cargo system having a deployable load floor prop rod. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1 and 2, a wheeled automotive or motor vehicle 10 is generally illustrated configured with passenger seating for transporting one or more passengers, such as a driver of the vehicle and additional passengers, and for further transporting one or more items as cargo onboard the motor vehicle 10. The motor vehicle 10 has a vehicle body 12 that generally defines a cabin interior 14. The cabin interior 14 may contain various features and trim components. The cabin interior 14 is shown having an arrangement of passenger seats 16 which may include a front row of passenger seats and one or more rear rows of passenger seats, each configured to seat a passenger. The motor vehicle 10 shown herein, in one example, is a sport utility vehicle (SUV), however, it should be appreciated that the motor vehicle 10 may otherwise be configured as a van, a sedan, a bus, a truck or other motor vehicle having a cargo area configurable to include a cargo storage system.

The motor vehicle 10 is shown as a wheeled motor vehicle having a plurality of wheel assemblies 18 on a chassis which generally supports the body 12. At the rear end of the motor vehicle 10 is a rear door shown in one example as a liftgate 26 which is generally configured to pivot about upper hinges between an open door position shown in FIGS. 1 and 2 which exposes the cabin interior 14 via a rear opening 24 and a closed door position which closes the rear opening 24. Located proximate to the rear of the motor vehicle 10 forward of the liftgate 26 and rearward of the rear row of passenger seats 16 is a rear cargo area 20 which has a cargo floor 22. The cargo floor 22 may include a cargo storage system 30 having a load floor cover 32 positionable over a storage compartment 38 to cover the storage compartment 38 and support a load on the top surface. One or more items of cargo may be located in the storage compartment 38, and cargo items may be placed on top of the load floor cover 32 in rear cargo area 20 when in the closed position. It should be appreciated that the load floor cover 32 and storage compartment 38 are easily accessible when the liftgate 26 is in the open position.

The motor vehicle 10 includes the cargo storage system 30 located in the rear cargo area 20 in the example shown. It is contemplated that the cargo storage system 30 may be located at another location in the motor vehicle 10 such as within the floor 22 in a middle region or front region such as a frunk compartment. The cargo storage system 30 has the load floor cover 32 which is configured to serve as a lid that is movable to convert between a closed position shown in FIG. 1 covering the storage compartment 38 and an open position shown in FIG. 2 exposing the storage compartment 38 and thereby allowing access to the storage compartment 38. The load floor cover 32 has a hinge 36 along one edge and a handle 34 proximate the opposite edge. To move from the closed position to the open position, the load floor cover 32 is rotated upward to an upright and a somewhat partially vertical position rearward of the seats 16. The open load floor cover 32 exposes the storage compartment 38 that is configured extending into and below the cargo floor 22 of the motor vehicle 10 to provide a cargo storage compartment. As such, the load floor cover 32 in the closed position covers the storage compartment 38 and provides a generally horizontal load floor that extends substantially flush with the cargo floor 22 to support cargo and other loads placed on top thereof.

The vehicle cargo storage system 30 includes a deployable load floor holder that is shown and described herein as a prop rod 40. The prop rod 40 is an elongated member having opposite ends and may be a tube, a beam, a stick or other structure capable of supporting the load floor cover 32. The prop rod 40 may be made of a polymeric material, metal or wood, according to various examples. The prop rod 40 is pivotally connected to the underside of the load floor cover 32. The prop rod 40 may be stowed in an elongated slot 42 in the underside of the load floor cover 32 when the prop rod 40 is not used to support the load floor cover 32 in the open position. The elongated slot 42 has a size and shape configured substantially similar to the size and shape of the prop rod 40 such that the prop rod 40 may be frictionally engaged and supported within the slot 42 when the prop rod 40 is not in use.

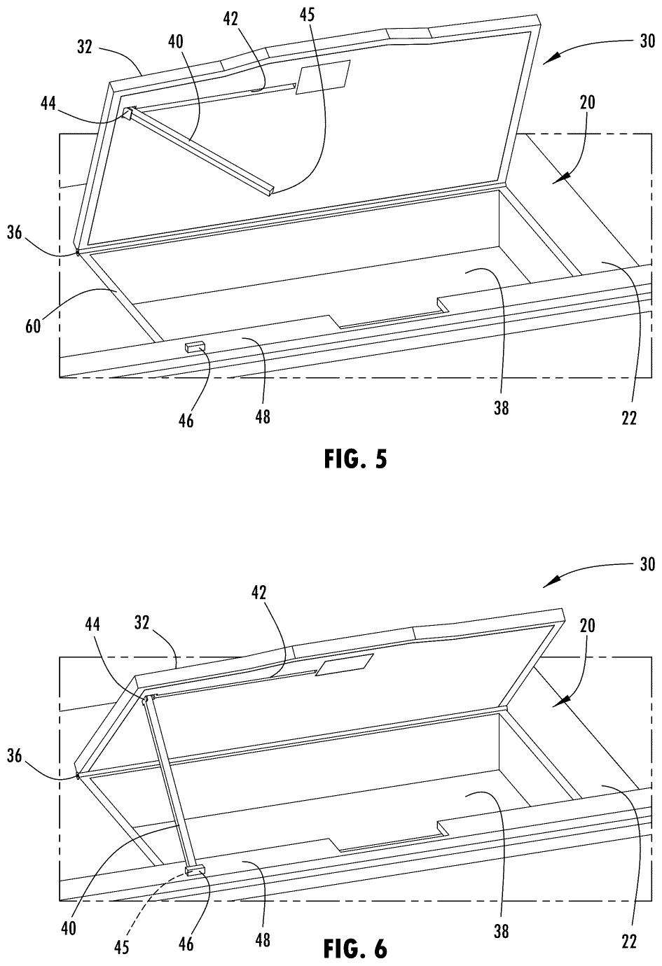

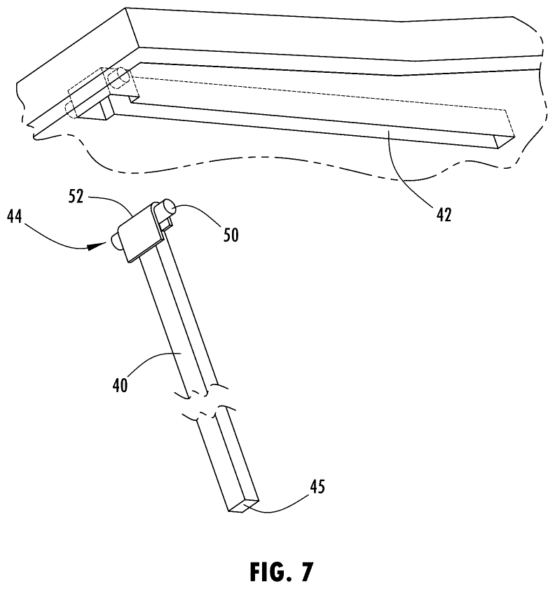

The prop rod 40 may be moved from the stowed position shown in FIG. 4 to a fully deployed position extending downward as shown in FIG. 6, which supports the load floor cover 32 and holds it propped in an open position. In doing so, the prop rod 40 may be pivoted about a hinge 44 at a first end away from the slot 42 as seen in FIG. 5 and further rotated downward to rest the lower opposite second end on a surface of the cargo floor 22, such as on a sill plate 48 as shown in FIG. 6. The sill plate 48 has an upstanding stop member 46 which may hold the extended end 45 of the prop rod 40 in the use position to hold the load floor cover 32 in the open position. In the open position, a user may access the storage compartment 38 without having to otherwise hold the load floor cover 32 in the open position.

The prop rod 40 has a hinge 44 connecting the prop rod 40 to the under surface of the load floor cover 32 within one end of the slot 42 in the embodiment shown. The hinge 44 may include a pivot pin 50 engaged within a pair of openings in the load floor cover 32. An outer knuckle or connector 52 may connect the end of the prop rod 40 to the pin 50 and allow a rotation of the prop rod 40 about the pin 50. As such, the connector 52 and prop rod 40 may rotate about the pin 50 while the prop rod 40 rotates between the stowed position shown in FIG. 4 and the fully deployed position shown in FIG. 6.

In operation, a user may engage the handle 34 in the load floor cover 32 and pull the load floor cover 32 upward such that it pivots about hinge 36 at an incline angle to an open position. The user may then engage the terminal end 45 of the prop rod 40 by reaching into the slot 42 and may forcibly rotate the prop rod 40 about hinge 44 with sufficient force to overcome friction between the prop rod 40 and slot 32 to rotate it to the downward fully deployed position. The lower terminal end 45 of the prop rod 40 may be placed in abutment with the upstanding member 46 on the sill plate 48 such that the load floor cover 32 is fully supported by the prop rod 40. To return the load floor cover 32 from the deployed position to the stowed position, the user may rotate the prop rod 40 back into the slot 42 and lower the load floor cover 32 onto the top edge 60 of the storage compartment 38.

Accordingly, the deployable load floor cover 32 having the prop rod 40 advantageously provides for an easy to use load floor cover 32 with hands free support that allows a user to easily access the vehicle storage compartment 38 below the load floor cover 32 when the load floor cover 32 is in the open position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle cargo storage system configured to be located in a floor of a vehicle, the vehicle cargo storage system comprising:
a compartment configured to extend into and below the floor of the vehicle;
a cover movable between a closed position covering the compartment and an upright open position to expose the compartment; and
a prop rod coupled to an underside of the cover, wherein the prop rod is configured to be stowed on the bottom side of the cover and is deployed to a deployed position extending downward from the cover to support the cover in the open position.

2. The vehicle cargo storage system of claim 1, wherein the prop rod comprises a hinge connecting one end of the prop rod to the bottom side of the cover.

3. The vehicle cargo storage system of claim 2, wherein the hinge comprises a pin rotatably coupled to a connector.

4. The vehicle cargo storage system of claim 1, wherein the cover has a slot on the bottom side, wherein the prop rod is stowed in the slot in the stowed position.

5. The vehicle cargo storage system of claim 1, wherein the slot is configured to frictionally engage the prop rod.

6. The vehicle cargo storage system of claim 1, wherein the cover is a load floor cover that provides a load floor in the closed position.

7. The vehicle cargo system of claim 6, wherein the compartment is located in a rear portion of the vehicle.

8. The vehicle cargo system of claim 1, wherein the prop rod has a terminal end configured to be supported on the cargo floor in the deployed position.

9. The vehicle cargo system of claim 8, wherein the prop rod is configured to engage a sill plate on the cargo floor.

10. The vehicle cargo system of claim 9, wherein the sill plate has a member configured to engage the terminal end of the prop rod.

11. The vehicle cargo system of claim 1, wherein the cover has a cover hinge.

12. A vehicle cargo storage system configured to be located in a cargo floor of a vehicle, the vehicle cargo storage system comprising:
a compartment configured to extend into and below the cargo floor of the vehicle;
a load floor cover movable between a closed position covering the compartment and providing a load floor and an upright open position to expose the compartment;
a prop rod pivotably coupled to a bottom side of the load floor cover, wherein the prop rod is configured to be stowed on the bottom side of the load floor cover and is deployed to a deployed position extending downward from the load floor cover to support the load floor cover in the open position; and
a hinge connecting one end of the prop rod to the bottom surface of the load floor cover.

13. The vehicle cargo storage system of claim 12, wherein the hinge comprises a pin rotatably coupled to a connector.

14. The vehicle cargo storage system of claim 12, wherein the load floor cover has a slot on the bottom side, wherein the prop rod is stowed in the slot in the stowed position.

15. The vehicle cargo storage system of claim 14, wherein the slot is configured to frictionally engage the prop rod.

16. The vehicle cargo system of claim 12, wherein the compartment is located in a rear portion of the vehicle.

17. The vehicle cargo system of claim 12, wherein the prop rod has a terminal end configured to engage the floor in the deployed position.

18. The vehicle cargo system of claim 17, wherein the prop rod is configured to engage a sill plate in the deployed position.

19. The vehicle cargo storage system of claim 18, wherein the sill plate has a member configured to engage the terminal end of the prop rod.

20. The vehicle cargo storage system of claim 12, wherein the cover has a cover hinge.
